(19) United States
(12) Patent Application Publication
(10) Pub. No.: US 2007/0218440 A1
(43) Pub. Date: Sep. 20, 2007

(54) COGNITIVE TRAINING USING MULTIPLE OBJECT TRACKING

(75) Inventors: Peter B. Delahunt, San Mateo, CA (US); Joseph L. Hardy, Richmond, CA (US); Henry W. Mahncke, San Francisco, CA (US); Sharona M. Atkins, Oakland, CA (US)

Correspondence Address: HUFFMAN LAW GROUP, P.C., 1900 MESA AVE., COLORADO SPRINGS, CO, 80906, US

(73) Assignee: POSIT SCIENCE CORPORATION, San Francisco, CA (US)

(21) Appl. No.: 11/611,241

(22) Filed: Dec. 15, 2006

Related U.S. Application Data
(60) Provisional application No. 60/750,509, filed on Dec. 15, 2005.
(60) Provisional application No. 60/806,063, filed on Jun. 28, 2006.

(51) Int. Cl. G09B 19/00

(52) U.S. Cl. 434/236

(57) ABSTRACT

Computer-implemented method for enhancing cognitive ability of a participant using multiple object tracking. One or more images are provided and are available for visual presentation to the participant. A plurality of images based on the one or more images are visually presented, including multiple target images and multiple distracter images, where each of the target images is graphically indicated for a first time period, and then each of the images is moved for a second time period during which the graphically indicating is not performed. The participant is then required to select the target images from the plurality of images, and a determination is made regarding the selection's correctness/incorrectness. The visually presenting, requiring, and determining are repeated one or more times in an iterative manner to improve the participant's cognition. The stimulus intensity may be adjusted each iteration based on the participant's response. Assessments may be performed.

### CROSS REFERENCE TO RELATED APPLICATION(S)

This application claims the benefit of the following U.S. Provisional Patent Applications, which are incorporated herein in their entirety for all purposes:

| Docket | | | |
|---|---|---|---|
| No. | Ser. No. | Filing Date: | Title: |
| PS.0119 | 60/750509 | Dec. 15, 2005 | HAWKEYE ASSESSMENTS |
| | | | SPECIFICATION |
| PS.0129 | 60/806063 | Jun. 28, 2006 | COMPUTER BASED TRAINING |
| | | | PROGRAM TO REVERSE AGE |
| | | | RELATED DECLINES IN |
| | | | MULTIPLE OBJECT TRACKING |

The following applications are related to the present application:

| | | | |
|---|---|---|---|
| PS.0217 | ******* | ******* | COGNITIVE TRAINING USING |
| | | | VISUAL SWEEPS |
| PS.0218 | ******* | ******* | COGNITIVE TRAINING USING |
| | | | VISUAL SEARCHES |
| PS.0220 | ******* | ******* | COGNITIVE TRAINING USING |
| | | | FACE-NAME ASSOCIATIONS |
| PS.0225 | ******* | ******* | COGNITIVE TRAINING USING |
| | | | EYE MOVEMENT |
| PS.0229 | ******* | ******* | COGNITIVE TRAINING USING |
| | | | VISUAL STIMULI |
| PS.0230 | ******* | ******* | VISUAL EMPHASIS FOR |
| | | | COGNITIVE TRAINING |

### FIELD OF THE INVENTION

This invention relates in general to the use of brain health programs utilizing brain plasticity to enhance human performance and correct neurological disorders, and more specifically, to a method for improving cognition of a participant, e.g., to improve divided attention (attending to multiple events simultaneously), sustained attention (attending for a prolonged period), motion processing, and visual memory, using multiple object tracking.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

As a more specific example, as adults age the speed of visual processing declines and there are reductions in attentional capacity, particularly for divided attention tasks. As a consequence, older people are less able to track multiple moving objects. For example, in one experimental tracking task, younger subjects could generally track four objects while older subjects could track 3. The ability to track multiple objects is essential in real world environments. The following are examples of tasks that require the ability to track the motion of multiple objects simultaneously: driving a car, navigating busy junctions either as a pedestrian or a driver, moving through a crowd, watching children in a swimming pool, and playing various sports—e.g. doubles tennis, including tracking the ball, the position of the opponents, and position of one's partner.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modern medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years, which only now through the application of computer technology can be brought out of the laboratory and into the everyday therapeutic treatment.

Thus, improved systems and methods for improving cognition, e.g., the ability of the visual nervous system of a participant to track multiple moving objects in a visual field, are desired.

### SUMMARY

Various embodiments of a computer-based exercise for enhancing cognition of a participant, e.g., to improve divided attention (attending to multiple events simultaneously), sustained attention (attending for a prolonged period), motion processing, and visual memory, e.g., by renormalizing and improving the ability of the visual nervous system of a participant to track multiple objects in a visual scene, are described. In embodiments of the present invention, a number of identical static objects (images) may be shown on a display, e.g., on a computer monitor. A plural subset of these objects may be identified or indicated as targets, e.g., by highlighting them. The indication may be removed, and the objects may move for a specified period of time, after which the participant is to indicate or select the target objects at the end of each trial. The number of objects may adapt to track the participant's performance using an adaptive staircase algorithm. A range of conditions may be used in the training, including different image/object speeds, different display sizes, overlapping vs. repelling objects, objects that can occlude the images, sizes of the target images and the distracter images, presentation time of the target images and the distracter images, eccentricity of initial locations of the target images, size of the visual field, and/or visual appearance of the images, e.g., visual emphasis, i.e., visual attributes that enhance distinction of the images against the background, e.g., color, luminance or color contrast, homogeneity, etc. of the images, and so forth.

Moreover, in various embodiments of the multiple object tracking exercise described herein, stimulus threshold assessments may also be performed in conjunction with, or as part of, the exercise, thus facilitating more effective training of the participant's cognitive systems, including, for example, visual processing and attentional systems.

First, one or more images may be provided, where the one or more images are available for visual presentation to the participant. For example, in one embodiment, the one or more images may include an image of a bubble, although other images may be used as desired.

A plurality of images based on the one or more images may be visually presented in a visual field to the participant, including a plurality of target images (also referred to as target objects) and a plurality of distracter images (or distracter objects). In one embodiment, all the images may be identical, although in other embodiments, images with different appearances may be presented. In one embodiment, the visual presentation may be invoked or initiated by the participant clicking a Start button (presented in a graphical user interface).

The visual presentation of the plurality of images preferably includes graphically indicating each of the plurality of target images for a first time period, and moving each of the plurality of images in the visual field for a second time period, where during the second time period the graphically indicating is not performed. In other words, the participant may temporarily be shown which of the plurality of images are target images, after which the images revert to their original appearance, which is indistinguishable from the distracter images, and the images may be moved, e.g., in random directions, for a specified period of time.

In preferred embodiments, the participant may perform the exercise described herein via a graphical user interface (GUI). The GUI preferably includes a visual field, in which may be displayed a plurality of images, in this case, identical circles. In some embodiments, the visually presenting may include setting initial positions for each of the plurality of images. For example, in some embodiments, the various images may be displayed at (possibly weighted) random positions in the visual field, while in other embodiments, the images may be placed according to some specified scheme, as desired. The target images may be initially positioned at various eccentricities with respect to the center of the visual field, referred to as the fixation point. Note that this distance may be a simple linear distance, or may refer to the angular distance from the fixation point to the image given a specified viewing distance from the screen.

In some embodiments, the moving may include setting initial speed and direction for each of the plurality of images. Similar to the initial positions, in some embodiments, setting the initial speed and direction for each of the plurality of images may include setting initial speed and direction for each of the plurality of images randomly, although other initialization schemes may be used as desired. In some embodiments, the moving may include changing the speed and/or direction of at least a subset of the plurality of images one or more times during the moving. In other words, in addition to bouncing off the boundaries of the visual field, the movement of the images may also include changing direction and/or speed, e.g., randomly, during the movement, thereby complicating the tracking task.

Thus, for example, in one embodiment, the range of possible speeds may be specified, e.g., by a tracking condition, e.g., 1-3 degrees/sec. The direction of each image may be chosen at random. Moreover, in one embodiment, on each frame of the movement, there may be a 5% chance that the speed will change at random within the speed range category, e.g., with a speed change range of between 0 and half the range maximum. Similarly, per movement frame, there may be a 5% chance that the direction will change, where the direction change may be chosen randomly from between 0 and 90 degrees. Note, however, that other probabilities and randomization schemes may be used as desired. These parameters may be specified by various conditions under which trials in the exercise may be performed, as discussed in more detail below. As noted above, the moving images may simply bounce off the walls of the visual field.

In preferred embodiments, visually presenting the plurality of image may include visually presenting the plurality of images at a specified stimulus intensity, which is an adjustable stimulus attribute or adaptive dimension that may be modified to make the tracking more or less difficult. For example, in a preferred embodiment, the stimulus intensity may be or include the number of target images of the visually presenting. In other words, the stimulus intensity may be the number of target images that the participant is expected to track. As another example, the stimulus intensity may be the presentation time of the images, i.e., the amount of time the images are displayed, e.g., the first time period and/or the second time period. As yet another example, the stimulus intensity may be the speed at which the images or objects move during tracking. Of course, other stimulus intensities may be used as desired, e.g., size of the target images and the distracter images, eccentricity of initial locations of the target images, number of occluders in the visual field, size of the visual field, visual appearance of the images, e.g., visual emphasis, i.e., visual attributes that enhance distinction of the images against the background, e.g., color, luminance or color contrast, homogeneity, etc. of the images, among others. In other words, the stimulus intensity may refer to any adjustable attribute of the stimulus and/or its presentation that may be modified to increase or decrease the difficulty of trials in the exercise. Thus, visually presenting the plurality of images may include visually presenting the plurality of images at a specified stimulus intensity, e.g., with a specified number of target images.

A stimulus intensity threshold refers to the value of stimulus intensity at which the participant achieves a specified level of success, e.g., a 69% success rate. The stimulus intensity may be dynamically adjusted to optimize the participant's learning rate in the exercise, as will be described in detail below.

In various embodiments, and over the course of the exercise, the visually presenting of may be performed under a variety of specified conditions that may make tracking the target images more or less difficult. As one example, in some embodiments, the positions and movements of the images may be constrained. For example, in some cases, the images may or may not be allowed to overlap. Conversely, in other embodiments (or under different conditions), such overlaps may be forbidden. In these cases, the images may repel one another, e.g., by elastic collisions, repellant forces, etc., as desired. Another example of a tracking condition is the number of occluders in the visual field, where an occluder is a region or object behind which images may move and be hidden. The use of such occluders may make tracking of the moving images more difficult, i.e., the more occluders used, the more difficult the tracking task. Thus, under various different conditions, the number of occluders may range from 0 to some specified maximum of occluders. Other tracking conditions are described below. Note that in various embodiments, attributes that specify any conditions for the trials may be used as a stimulus intensity (or intensities), and may thus be adjusted dynamically, e.g., using a maximum likelihood procedure, as described below in detail.

In some embodiments, constraints may be applied regarding initial and/or final positions of the images. For example, even under conditions or tasks allowing overlaps and/or occluders, overlaps and/or occlusion may be disallowed before movement begins, and at the end of movement, thus preventing target images from being hidden, and thus unselectable by the participant. This may be achieved in any of a number of ways, including, for example, by allowing motion to continue until no overlap or occlusion is in effect, or by constraining or enhancing motion or positions of the images to avoid these conditions (at the beginning and end of movement), among others. Thus, in some embodiments, when using occluders, the target images may not be positioned behind the occluders before motion begins. Moreover, the occluders may be removed before the participant's response is made. Similarly, when overlapping is allowed, the target images may not be allowed to overlap each other when the trial is over, and so to accommodate this, the trial may be extended until all targets are not overlapping with any other image.

The participant may then be required to select or indicate the target images from among the plurality of distracter images. Said another way, a period of time may be provided in which the participant is to select the target images. The participant may (attempt to) select the target image from among the plurality of images in any of a number of ways. For example, selection of an image may be performed by the participant placing a cursor over the image and clicking a mouse. In one embodiment, requiring the participant to select the target images may include allowing the participant to make a number of selections, where the number of selections is equal to the number of target images. Thus, in a trial where there are four target images, the participant may be allowed only four “clicks” or selections to indicate the target images. In other embodiments, one or more additional selections may be permitted, i.e., allowing one or more mistakes to be made while still being able to select all the target images. In some embodiments, the selections made by the participant may be recorded.

Next, a determination may be made as to whether the participant selected the target images correctly. In other words, the method may determine the number of target images correctly selected or indicated by the participant. In one embodiment, the method may include recording the participant's success at selecting the target images, e.g., the fraction of target images correctly selected by the participant.

In some embodiments, in indication may be provided as to whether the participant selected the target images correctly, where the indicating is performed audibly and/or graphically. In one embodiment, the indicating whether the participant selected the target images correctly may be performed for each selection. Thus, each time the participant correctly selects a target image, a visual and/or auditory indication may be provided. For example, a “ding” may be played upon correct incorrect selection of a target image, and/or a “thunk” may be played upon incorrect selection of a target image. Graphical indicators may also be used as desired. In some embodiments, points may be awarded based on the number of target images correctly selected.

In one embodiment, the method may further include graphically indicating each of the plurality of target images after the above determining. In other words, once the participant has completed the (attempted) selection of the target images, and the determination has been made as to the correctness of the selections, all the target images for the trial may be graphically indicated, e.g., via highlighting. Note that the above visually presenting, requiring, and determining may compose performing a trial in the exercise.

The visually presenting, requiring, and determining may be repeated one or more times in an iterative manner, to improve the participant's cognition, e.g., to improve the participant's divided attention (attending to multiple events simultaneously), sustained attention (attending for a prolonged period), motion processing, and visual memory. In other words, a plurality of trials may be performed in the exercise as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance for that participant.

Such repeating preferably includes performing a plurality of trials under each of a plurality of conditions (e.g., tracking conditions), where each condition specifies one or more attributes of the plurality of images or their presentation. Such conditions may include baseline conditions, used before, after, and at specified points during, the exercise to assess the participant's performance, and non-baseline or training conditions, used for the actual training during the exercise. Thus, blocks of stimuli may contain particular conditions affecting the difficulty of the multiple object tracking task.

The participant may progress through a plurality of levels of the exercise based on the participant's success rate at each level, where each level may be associated with respective subsets of the conditions. Thus, for example, initial levels may include trials performed under the easiest conditions, and successive, more difficult, levels may include trials performed under more difficult conditions.

In some embodiments, the exercise may include multiple levels, e.g., two levels, e.g., a first, easier, level, in which no occluders are used, and a second, more difficult, level, in which occluders are used. The user may choose which of these “levels” to use at the start, and if the easier one is chosen the user may advance to the harder one after some specified number, e.g., 5, of successful trials. In another embodiment, the two levels may be characterized by the number of images used, where, for example, the first level may use a smaller number of target images, e.g., 3, and the second level may use a greater number of target images, e.g., 7. Of course, in other embodiments, there may be more than two levels, and the levels may utilize any of various conditions.

In one embodiment, the repeating may include modifying or adjusting the stimulus intensity of the presented stimuli based on the participant's response. For example, as noted above, in a preferred embodiment, the stimulus intensity may be the number of target images presented. Thus, in each trial, and in response to the participant's indicated selection of the target images, the stimulus intensity, i.e., the number of target images, may be adjusted for the next trial's visual presentation, i.e., based on whether the participant indicated all the target images correctly (or not). The adjustments may generally be made to increase the difficulty of the stimulus when the participant answers correctly (e.g., increasing the number of target images by one), and to decrease the difficulty of the stimulus when the participant answers incorrectly (e.g., decreasing the number of target images by one). Moreover, the adjustments may be made such that a specified level of performance, i.e., level of success, is approached and substantially maintained during performance of the exercise. For example, based on the participant's responses, the intensity of the multiple object tracking may be adjusted to substantially achieve and maintain a specified success rate, e.g., 85% or 90%, for the participant, although other success rates may be used as desired. In one embodiment, the exercise may begin with 3 target images, although in other embodiments, this initial value may be determined by a pre-exercise calibration or threshold determination, as described below in more detail.

In preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition, the multiple object tracking may be presented (and adjusted) in accordance with a maximum likelihood procedure (e.g., ZEST) applied to trials under that condition. Moreover, as described below, the repeating may also include performing threshold assessments in conjunction with, or as part of, the exercise, e.g., using a dual-stair maximum likelihood procedure, e.g., ZEST.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a high-level flowchart of one embodiment of a method for cognitive training using multiple object tracking, according to one embodiment;

FIG. 4 illustrates an exemplary screenshot of a graphical user interface (GUI) for multiple object tracking, where target images are indicated by highlighting, according to one embodiment;

FIG. 5 illustrates an exemplary screenshot of a GUI for multiple object tracking, where target images are indicated by revealing their contents, according to one embodiment;

FIG. 6 illustrates an exemplary screenshot of a GUI for multiple object tracking, where images are allowed to overlap, according to one embodiment;

FIG. 7 illustrates an exemplary screenshot of a GUI for multiple object tracking, where images are allowed to move behind occluders, according to one embodiment;

FIG. 8 illustrates an exemplary screenshot of a GUI for multiple object tracking, indicating correctness/incorrectness of participant selections, according to one embodiment;

FIG. 9 illustrates an exemplary screenshot of a GUI for multiple object tracking, indicating target images by high-lighting and correctness/incorrectness of participant selections, according to one embodiment; and

FIG. 10 illustrates convergence to a threshold value over a series of trials in an exemplary two-stair ZEST threshold procedure.

### DETAILED DESCRIPTION

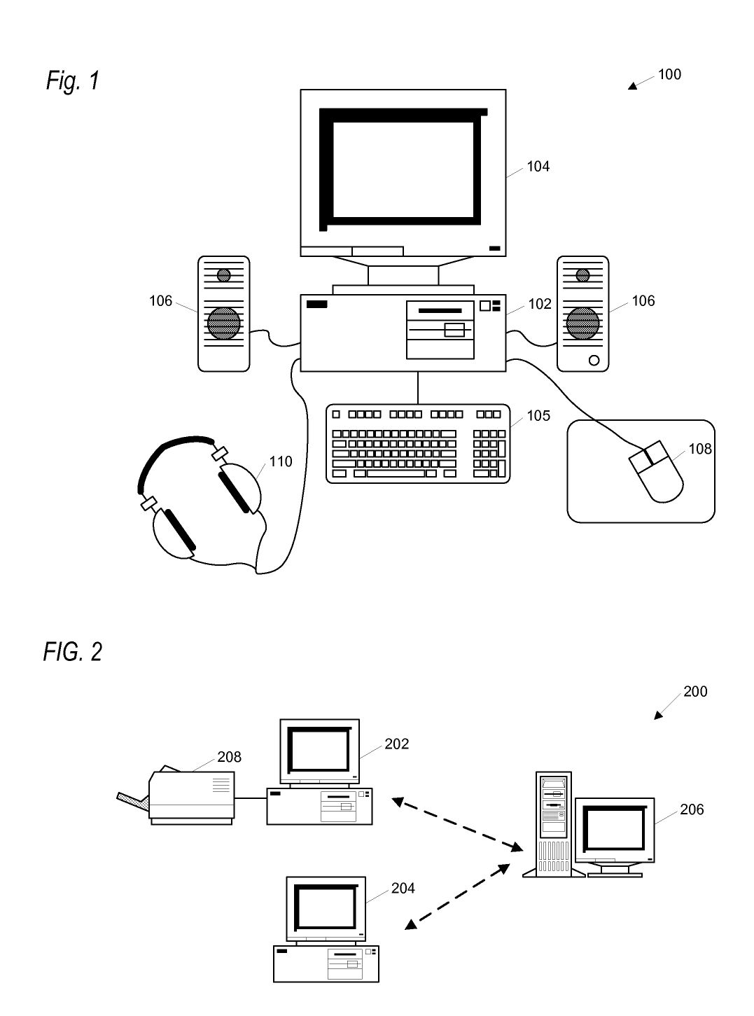

Referring to FIG. 1, a computer system 100 is shown for executing a computer program to train, or retrain an individual according to the present invention to enhance cognition, where the term “cognition” refers to the speed, accuracy and reliability of processing of information, and attention and/or memory, and where the term “attention” refers to the facilitation of a target and/or suppression of a non-target over a given spatial extent, object-specific area or time window. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. In some embodiments, the speakers 106 and the headphones 110 may provide auditory prompting and feedback to the subject during execution of the computer program. The mouse 108 allows the subject to navigate through the computer program, and to select particular responses after visual or auditory prompting by the computer program. The keyboard 105 allows an instructor to enter alphanumeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can review the information and can then download configuration and control information pertaining to a particular subject, back to the subject's computer 202, 204.

Overview of Multiple Object Tracking Exercise

Embodiments of the computer-based exercise described herein may operate to improve the participant's cognition, e.g., to improve divided attention (attending to multiple events simultaneously), sustained attention (attending for a prolonged period), motion processing, and visual memory, e.g., by renormalizing and improving the ability of the visual nervous system of a participant to track multiple objects in a visual scene, e.g., to reverse declines in multiple object tracking. In embodiments of the present invention, a number of identical static objects (images) may be shown on a display, e.g., on a computer monitor. A plural subset of these objects may be identified or indicated as targets, e.g., by highlighting them. The indication may be removed, and the objects may move for a specified period of time, after which the participant is to indicate or select the target objects at the end of each trial. The number of objects may adapt to track the participant's performance using an adaptive staircase algorithm. A range of conditions may be used in the training, including different image/object speeds, different display sizes, overlapping vs. repelling objects, objects that can occlude the images, and so forth.

It should be noted that in various embodiments of the multiple object tracking exercise described herein, stimulus threshold assessments may also be performed in conjunction with, or as part of, the exercise, thus facilitating more effective training of the participant's cognitive systems.

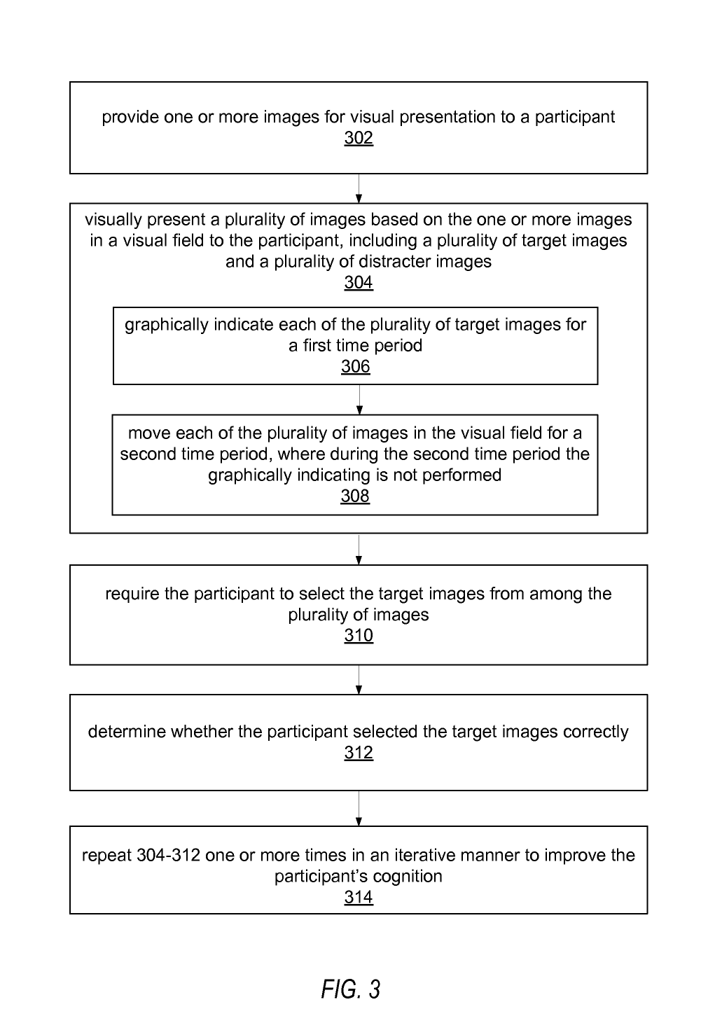

FIG. 3—Flowchart of a Method for Cognitive Training Using Multiple Object Tracking

FIG. 3 is a high-level flowchart of one embodiment of a method for cognitive training using multiple object tracking. It should be noted that in various embodiments, some of the method elements may be performed concurrently, in a different order than shown, or may be omitted. Additional method elements may also be performed as desired. As shown, the method may be performed as follows:

In 302, one or more images may be provided, where the one or more images are available for visual presentation to the participant. The images may be of any type desired. For example, in one embodiment, the one or more images may include an image of a bubble, as will be described below and illustrated in various figures. In some embodiments, the images may include or be associated with various items, e.g., bonus items, as will be described below

In 304, a plurality of images based on the one or more images may be visually presented in a visual field to the participant, including a plurality of target images (also referred to as target objects) and a plurality of distracter images (or distracter objects). In one embodiment, all the images may be identical, although in other embodiments, images with different appearances may be presented. In one embodiment, the visual presentation of 304 may be invoked or initiated by the participant clicking a Start button (presented in a graphical user interface).

The visual presentation of the plurality of images preferably includes graphically indicating each of the plurality of target images for a first time period, as shown in 304, and moving each of the plurality of images in the visual field for a second time period, where during the second time period the graphically indicating of 304 is not performed, as shown in 306. In other words, the participant may temporarily be shown which of the plurality of images are target images (304), after which the images revert to their original appearance, which is indistinguishable from the distracter images, and the images may be moved, e.g., in random directions, for a specified period of time.

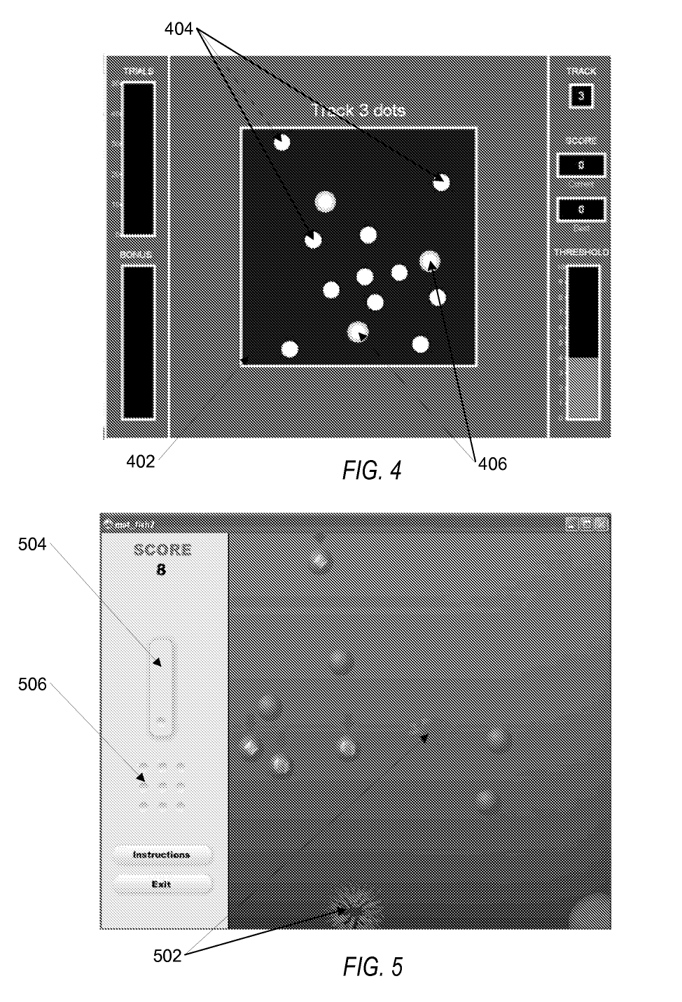

In preferred embodiments, the participant may perform the exercise described herein via a graphical user interface (GUI). FIG. 4 illustrates an exemplary screenshot of a graphical user interface (GUI) for a multiple object tracking task, according to one embodiment. As may be seen, the GUI preferably includes a visual field 402, in which may be displayed a plurality of images, in this case, identical circles. In some embodiments, the visually presenting 304 may include setting initial positions for each of the plurality of images. For example, in some embodiments, the various images may be displayed at (possibly weighted) random positions in the visual field, while in other embodiments, the images may be placed according to some specified scheme, e.g., according to a 2-dimensional low-discrepancy sequence, a perturbed regular grid, e.g., a polar coordinate grid, etc., as desired. The target images may be initially positioned at various eccentricities with respect to the center of the visual field, referred to as the fixation point. Note that this distance may be a simple linear distance, or may refer to the angular distance from the fixation point to the image given a specified viewing distance from the screen. For example, exemplary eccentricity values may include 10, and 20 degrees (or equivalents), at a viewing distance of 35 cm, although other values may be used as desired.

As FIG. 4 also shows, in this embodiment, target images 406 are indicated via highlighting, whereas the distracter images 404 are not. It should be noted, however, that other means of indicating the target images 406 may be used as desired, as illustrated in FIG. 5, described below. Note that in the example screen of FIG. 4, the background is simple, specifically, a blank field, and so does not complicate the multiple object tracking task. However, in other embodiments or tracking conditions, the background may be more complex and confusing to the participant, thereby making multiple object tracking more difficult. An example of such a complex background is shown in FIG. 5, described below.

As FIG. 4 also shows, in some embodiments, the GUI may include various indicators regarding aspects of the exercise, such as, for example, indicators for bonus points and trials performed in the exercise, as shown on the left side of the GUI, and labeled accordingly, as well as indicators for the number of target images being tracked, labeled “tracks”, the participant's score, including a current value and a best value, labeled accordingly, and a threshold indicator, so labeled, which indicates the value of a stimulus intensity for the tracking task, explained in detail below. Of course, in other embodiments, other indicators or controls may be included in the GUI as desired.

FIG. 5 illustrates an exemplary screenshot of a graphical user interface (GUI) for a multiple object tracking task, according to another embodiment, where the exercise is presented as a game called “Jewel Diver”. As shown, in this embodiment, the various images are of bubbles, and are displayed in an underwater scene that includes additional objects 502, such as a fish and sea urchin, which in some embodiments may be operable to hide or occlude one or more of the images, as discussed below. The target images, indicated by downward pointing arrows, each contains a respective jewel, which may be shown during the graphically indicating of 306. In other words, in this embodiment, before the movement of 308 begins, the normally opaque target bubbles may temporarily become transparent, displaying the respective jewels contained therein.

As may be seen, the GUI of FIG. 5 includes a score indicator, so labeled, as well as an indicator 504 for the number of jewels won by the participant (by correctly selecting target images). Thus, as the target images are correctly selected by the participant, the respective jewels may be moved from the bubbles to the jewel indicator (see, e.g., FIG. 9, described below). Below the jewel indicator 504 is a bonus counter or indicator 506 that may count or indicate the number of trials in which all the target images were correctly selected, e.g., in which all the jewels for the trial were collected. For example, each time all the jewels have been collected (for a trial), a pearl may appear in one of the slots of the bonus counter 506. In other words, if the user correctly selects all the target images in a trial, one of the dots or slots in the bonus indicator 506 may be activated or filled and bonus points awarded. As shown, in this particular case, a maximum of nine such bonuses may be counted, at which point, additional bonus points may be awarded. In one embodiment, once all the bonus slots in the bonus counter are filled, the participant may progress to a next level in the exercise, as will be described in more detail below.

As FIG. 5 also shows, the GUI includes a control, e.g., a button, for invoking display of instructions, labeled “instructions”, as well as an exit button for exiting the task or exercise, labeled “exit”. It should be noted that these particular GUI elements are meant to be exemplary only, and are not intended to limit the GUIs contemplated to any particular form, function, or appearance.

In some embodiments, the moving 306 may include setting initial speed and direction for each of the plurality of images. Similar to the initial positions, in some embodiments, setting the initial speed and direction for each of the plurality of images may include setting initial speed and direction for each of the plurality of images randomly, although other initialization schemes may be used as desired. In some embodiments, the moving 306 may include changing the speed and/or direction of at least a subset of the plurality of images one or more times during the moving. In other words, in addition to bouncing off the boundaries of the visual field, the movement of the images may also include changing direction and/or speed, e.g., randomly, during the movement, thereby complicating the tracking task.

Thus, for example, in one embodiment, the range of possible speeds may be specified, e.g., by a tracking condition, e.g., 1-3 degrees/sec. The direction of each image may be chosen at random. Moreover, in one embodiment, on each frame of the movement, there may be a 5% chance that the speed will change at random within the speed range category, e.g., with a speed change range of between 0 and half the range maximum. Similarly, per movement frame, there may be a 5% chance that the direction will change, where the direction change may be chosen randomly from between 0 and 90 degrees. Note, however, that other probabilities and randomization schemes may be used as desired. These parameters may be specified by various conditions under which trials in the exercise may be performed, as discussed in more detail below. As noted above, the moving images may simply bounce off the walls of the visual field.

In preferred embodiments, visually presenting the plurality of image may include visually presenting the plurality of images at a specified stimulus intensity, which is an adjustable stimulus attribute or adaptive dimension that may be modified to make the tracking more or less difficult. For example, in a preferred embodiment, the stimulus intensity may be or include the number of target images of the visually presenting of 304. In other words, the stimulus intensity may be the number of target images that the participant is expected to track. Thus, visually presenting the plurality of images may include visually presenting the plurality of images at a specified stimulus intensity, e.g., with a specified number of target images. As another example, the stimulus intensity may be the presentation time of the images, i.e., the amount of time the images are displayed. As yet another example, the stimulus intensity may be the speed at which the images or objects move during tracking. Of course, other stimulus intensities may be used as desired, e.g., size of the target images and the distracter images, eccentricity of initial locations of the target images, number of occluders in the visual field, size of the visual field, visual appearance of the images, e.g., visual emphasis, i.e., visual attributes that enhance distinction of the images against the background, e.g., color, luminance or color contrast, homogeneity, etc. of the images, among others. In other words, in various embodiments, the stimulus intensity may refer to any adjustable attribute of the stimulus and/or its presentation that may be modified to increase or decrease the difficulty of trials in the exercise.

A stimulus intensity threshold refers to the value of stimulus intensity at which the participant achieves a specified level of success, e.g., a 69% success rate. The stimulus intensity may be dynamically adjusted to optimize the participant's learning rate in the exercise, as will be described in detail below.

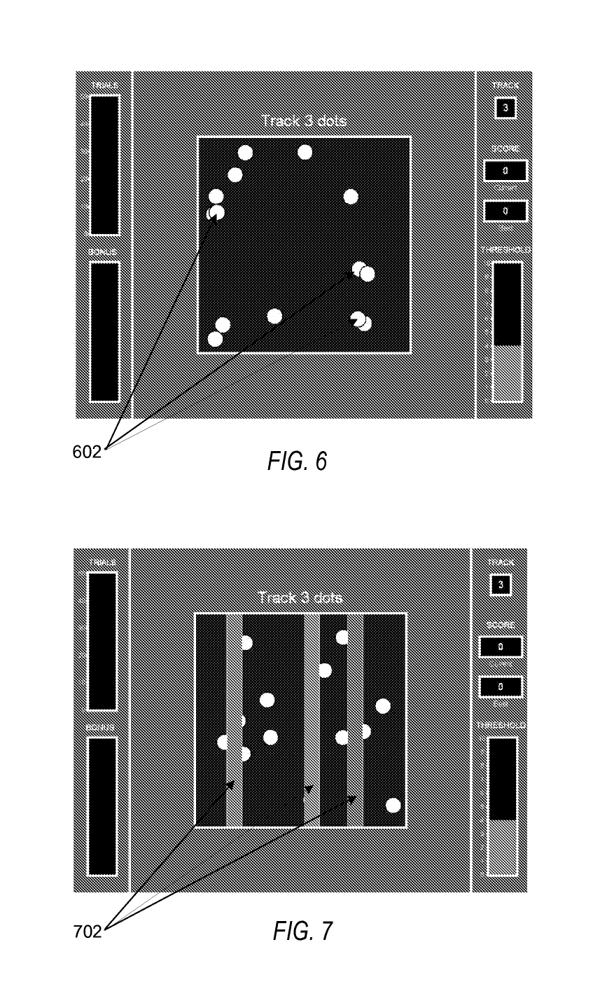

In various embodiments, and over the course of the exercise, the visually presenting of 304 may be performed under a variety of specified conditions that may make tracking the target images more or less difficult. As one example, in some embodiments, the positions and movements of the images may be constrained. For example, in some cases, the images may or may not be allowed to overlap. FIG. 6 is a screen shot of a GUI similar to that of FIG. 4, where, as may be seen, overlap of images is allowed, as illustrated by the various image overlaps 602 shown. Conversely, in other embodiments (or under different conditions), such overlaps may be forbidden. In these cases, the images may repel one another, e.g., by elastic collisions, repellant forces, etc., as desired. Another example of a tracking condition is the number of occluders in the visual field, where an occluder is a region or object behind which images may move and be hidden. FIG. 7 is a screen shot of a GUI where the tracking condition includes a specified number of occluders (in this particular case, three). The use of such occluders may make tracking of the moving images more difficult, i.e., the more occluders used, the more difficult the tracking task. Thus, under various different conditions, the number of occluders may range from 0 to some specified maximum of occluders. Other tracking conditions are described below. Note that in various embodiments, attributes that specify any conditions for the trials may be used as a stimulus intensity (or intensities), and may thus be adjusted dynamically, e.g., using a maximum likelihood procedure, as described below in detail.

In some embodiments, constraints may be applied regarding initial and/or final positions of the images. For example, even under conditions or tasks allowing overlaps and/or occluders, overlaps and/or occlusion may be disallowed before movement begins, and at the end of movement, thus preventing target images from being hidden, and thus unselectable by the participant. This may be achieved in any of a number of ways, including, for example, by allowing motion to continue until no overlap or occlusion is in effect, or by constraining or enhancing motion or positions of the images to avoid these conditions (at the beginning and end of movement), among others. Thus, in some embodiments, when using occluders, the target images may not be positioned behind the occluders before motion begins. Moreover, the occluders may be removed before the participant's response is made. Similarly, when overlapping is allowed, the target images may not be allowed to overlap each other when the trial is over, and so to accommodate this, the trial may be extended until all targets are not overlapping with any other image.

In 306, the participant may be required to select or indicate the target images from among the plurality of distracter images. Said another way, a period of time may be provided in which the participant is to select the target images. The participant may (attempt to) select the target image from among the plurality of images in any of a number of ways. For example, selection of an image may be performed by the participant placing a cursor over the image and clicking a mouse. In one embodiment, requiring the participant to select the target images may include allowing the participant to make a number of selections, where the number of selections is equal to the number of target images. Thus, in a trial where there are four target images, the participant may be allowed only four “clicks” or selections to indicate the target images. In other embodiments, one or more additional selections may be permitted, i.e., allowing one or more mistakes to be made while still being able to select all the target images. In some embodiments, the selections made by the participant may be recorded.

In 308, a determination may be made as to whether the participant selected the target images correctly. In other words, the method may determine the number of target images correctly selected or indicated by the participant. In one embodiment, the method may include recording the participant's success at selecting the target images, e.g., the fraction of target images correctly selected by the participant.

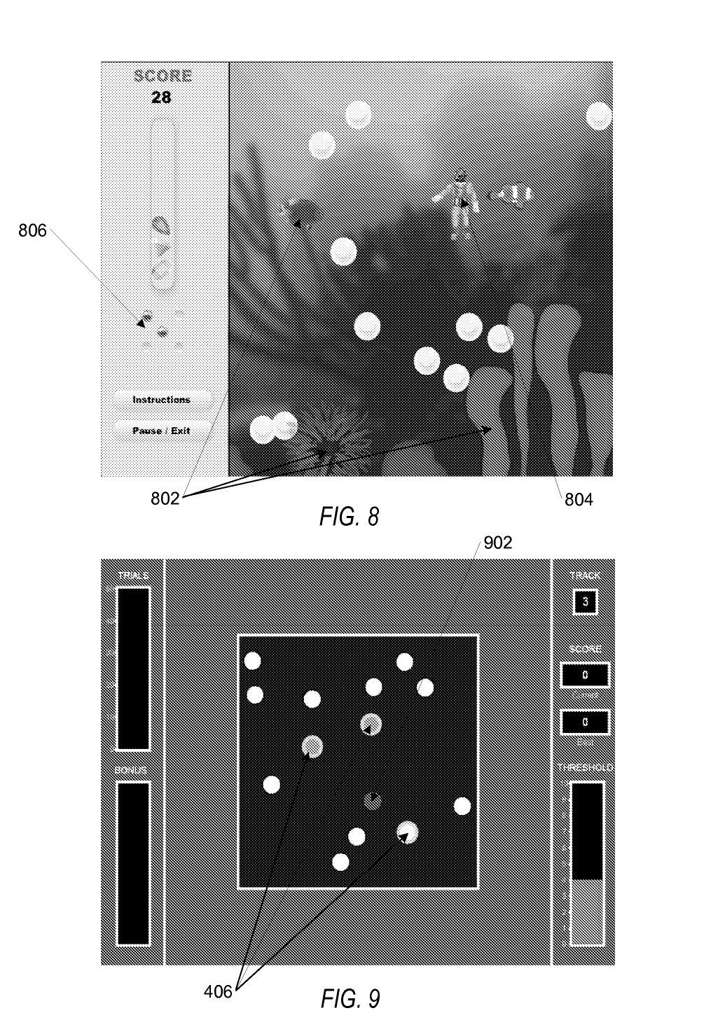

In some embodiments, in indication may be provided as to whether the participant selected the target images correctly, where the indicating is performed audibly and/or graphically. In one embodiment, the indicating whether the participant selected the target images correctly may be performed for each selection. Thus, each time the participant correctly selects a target image, a visual and/or auditory indication may be provided. For example, a “ding” may be played upon correct incorrect selection of a target image, and/or a “thunk” may be played upon incorrect selection of a target image. Graphical indicators may also be used as desired. For example, in an embodiment corresponding to the GUI of FIG. 5, where each target object includes a jewel, upon selection of a target image/object, the jewel may appear and be moved to the jewel counter 504, e.g., as an animation. This visual indication may be performed instead of, or in addition to, any auditory indication (e.g., a “ding”, etc.). In some embodiments, points may be awarded based on the number of target images correctly selected. FIG. 8 is a screenshot of an exemplary GUI that illustrates the above. As may be seen, in this embodiment, the participant has correctly selected three target images correctly, and so there are three jewels in the jewel counter 504. In this embodiment, the participant has made these selections by moving the cursor, in this case, diver 804, over the image (bubble) with a mouse, and clicking the mouse. This GUI also illustrates a variety of occluders 802, specifically, two fish, a sea urchin, and, in the bottom right of the visual field, kelp. Similar to the GUI of FIG. 5, this GUI also includes a bonus counter 806, this time with five slots. As with the GUI of FIG. 5, each time the participant correctly selects all the target images (collects all the jewels) in a trial, a pearl may appear in a slot of the bonus counter 806, here shown with two pearls. In one embodiment, once the bonus counter is full, the participant may progress to the next level in the exercise. Of course, in other embodiments, other schemes for level promotion may be used as desired.

In one embodiment, the method may further include graphically indicating each of the plurality of target images after the determining. In other words, once the participant has completed the (attempted) selection of the target images, and the determination has been made as to the correctness of the selections, all the target images for the trial may be graphically indicated, e.g., via highlighting. FIG. 9 is a screenshot of an exemplary GUI, similar to those of FIGS. 4, 6, and 7, that illustrates both the graphical indication of correctness/incorrectness per selection, and the graphical indication of the target images after the selections have been completed. In the embodiment of FIG. 9, there are three target images 906. Upon correct selection of a target image, the selected target image may change color, e.g., to green, to indicate the correctness of the selection, as illustrated by the two upper target images 902, whereas upon incorrect selection of an image, the selected image may change color, e.g., to red, to indicate the incorrectness of the selection, as illustrated by image 902. As FIG. 9 also shows, each of the target images 906 are shown highlighted, so that whichever selections the participant has made, the actual target images 906 are clearly indicated.

Note that the above visually presenting, requiring, and determining of 304, 306, and 308 may compose performing a trial in the exercise.

In 314, the visually presenting, requiring, and determining of 304 (including 306 and 308), 310, and 312 may be repeated one or more times in an iterative manner, to improve the participant's cognition, e.g., to improve divided attention (attending to multiple events simultaneously), sustained attention (attending for a prolonged period), motion processing and visual memory, by training the participant's visual spatiotemporal tracking ability.

In other words, a plurality of trials may be performed in the exercise as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance for that participant.

Such repeating preferably includes performing a plurality of trials under each of a plurality of conditions (e.g., tracking conditions), where each condition specifies one or more attributes of the plurality of images or their presentation. Such conditions may include baseline conditions, used before, after, and at specified points during, the exercise to assess the participant's performance (described further below), and non-baseline or training conditions, used for the actual training during the exercise. Thus, blocks of stimuli may contain particular conditions affecting the difficulty of the multiple object tracking task.

The participant may progress through a plurality of levels of the exercise based on the participant's success rate at each level, where each level may be associated with respective subsets of the conditions. Thus, for example, initial levels may include trials performed under the easiest conditions, and successive, more difficult, levels may include trials performed under more difficult conditions. For example, in one embodiment using the GUI of FIG. 8 (or FIG. 5), where the images are bubbles in an underwater scene, and the target images include hidden jewels to be collected by the participant, each time the participant collects all the jewels in a trial, a pearl may be added to the bonus counter 806, here shown with two pearls, and when the bonus counter is full, the participant may progress to the next level, where trials are performed under more difficult conditions.

In some embodiments, the exercise may include multiple levels, e.g., two levels, e.g., a first, easier, level, in which no occluders are used, and a second, more difficult, level, in which occluders are used. The user may choose which of these “levels” to use at the start, and if the easier one is chosen the user may advance to the harder one after some specified number, e.g., 5, of successful trials. In another embodiment, the two levels may be characterized by the number of images used, where, for example, the first level may use a smaller number of target images, e.g., 3, and the second level may use a greater number of target images, e.g., 7. Of course, in other embodiments, there may be more than two levels, and the levels may utilize any of various conditions.

In some embodiments, the conditions may specify one or more of: movement of the target images and the distracter images, sizes of the target images and the distracter images, presentation time of the target images and the distracter images, including the first time period and/or the second time period (see 304 above), eccentricity of initial locations of the target images, number of occluders in the visual field, where each occluder is operable to occlude target images and distracter images that move behind the occluder, size of the visual field, and/or visual appearance of the images, e.g., visual emphasis, i.e., visual attributes that enhance distinction of the images against the background, e.g., color, luminance or color contrast, homogeneity, etc. of the images, among others. Specifying movement of the target images and the distracter images may include specifying one or more of: speed of the target images and the distracter images, and/or whether or not the target images and the distracter images can overlap. Specifying speed of the target images and the distracter images may include specifying a range of speed for the target images and the distracter images.

The following is one exemplary set of conditions that may be used over the course of the exercise, although other conditions may be used as desired. Note that a condition specifies a group of one or more attributes regarding the images and/or their presentation, including movement, and that the various values of the attributes may thus define a grid of conditions. The below attributes and values are meant to be exemplary only, and it should be noted that in various embodiments, the conditions may specify other attributes and values as desired.

Exemplary Conditions/Attributes

In one embodiment, a condition may specify whether or not the images may overlap, i.e., whether the images may overlap or repel one another, as well as whether or not occluders are included in the visual field. Thus, the possible (four) combinations of these two attributes may include: repel (no overlap) with no occluders, overlap with no occluders, repel with occluders, and overlap with occluders. In one embodiment, these four combinations may characterize four tasks in the exercise. In other words, the exercise may include four different multiple object tracking tasks respectively characterized by these four attribute combinations. Trials in each task may be performed under a variety of other conditions, such as the following:

A condition may specify display size, image size, number of images, and number of occluders. For example, the following are example data (sub)sets for these attributes, and may be referred to as “setups”:

Setup 1: number of images=12, size (i.e., side) of visual field (deg)=14, size of each image (deg)=1.25, number of occluders=2.

Setup 2: number of images=14, size of visual field (deg)=18, size of each image (deg)=1.33, number of occluders=3.

Setup 3: number of images=16, side of visual field (deg)=24, size of each image (deg)=1.5, number of occluders=4.

A condition may also specify various display times for the visual presentation of the images. For example, a condition may specify one of three trial display times: 4, 7, and 10 seconds. In a preferred embodiment, the display time may include only the second time period (of 308), i.e., the movement portion of the visual presentation, although in other embodiments, the display time may include only the first time period, or both the first time period (of 306) and the second time period.

A condition may also specify a speed range for movement of the images. For example, a condition may specify one of three speed ranges (e.g., in degrees/second): 2-4 deg/s, 3-6 deg/s, or 5-10 deg/s.

A condition may also specify the eccentricity of the initial positions of the target images with respect to the fixation point (center) of the visual field. For example, one of three eccentricity values may be specified: 5 deg, 10 deg, or 15 deg, although other values may be used as desired.

Note that when angular measures are used (e.g., deg, deg/s), a nominal viewing distance may be assumed, e.g., 57 cm, at which these angular values correspond to linear distances.

In one embodiment, the above conditions may be grouped into a plurality of categories. For example, the categories may respectively include: the four overlap/occluder tasks mentioned above; the above setups; the trial display times; and the speed ranges, although other categories may be used as desired.

Thus, each condition may specify values for each of the above attributes (or others), possibly in the categories or groupings presented, although it should be noted that other organizations of the data are also contemplated.

The following describes a trial in one exemplary embodiment of the Jewel Diver version of the exercise:

Trial Initiation:

The participant may initiate a trial by clicking a Start button presented in the GUI.

Stimulus Presentation:

14 non-overlapping circular bubbles may be displayed in a presentation region (i.e., visual field) of the screen, and 1-7 of the bubbles may be designated and indicated or highlighted as targets (containing illustrations of gems) for approximately two seconds, after which a 4-second period may follow when all 14 bubbles appear identical (no highlighting of targets) and are moving on the screen. The initial direction of motion may be random at first, and on each frame there may be a 5% chance that either the speed or the direction of motion of each stimulus will change at random. Stimuli may change direction when they contact either a border of the presentation region or another stimulus.

Participant Response:

The participant may click on bubbles to identify targets, where the number of available clicks equals the number of targets. After each correctly identified target, reward feedback may be given in the form of a “ding” sound, points, and an animation of the jewel moving to the jewel counter. After each incorrect response, a “thunk” sound may be played. After the participant has used all the available clicks, if all targets were correctly identified, an additional animation may play, otherwise if one or more targets were incorrectly identified, no additional animation may be played. Finally, the Start button may be displayed again, whereby the participant may invoke the next trial.

In one embodiment, the repeating may include modifying or adjusting the stimulus intensity of the presented stimuli based on the participant's response. For example, as noted above, in a preferred embodiment, the stimulus intensity may be the number of target images presented. Thus, in each trial, and in response to the participant's indicated selection of the target images, the stimulus intensity, i.e., the number of target images, may be adjusted for the next trial's visual presentation, i.e., based on whether the participant indicated all the target images correctly (or not). The adjustments may generally be made to increase the difficulty of the stimulus when the participant answers correctly (e.g., increasing the number of target images by one), and to decrease the difficulty of the stimulus when the participant answers incorrectly (e.g., decreasing the number of target images by one). Moreover, the adjustments may be made such that a specified level of performance, i.e., level of success, is approached and substantially maintained during performance of the exercise. For example, based on the participant's responses, the intensity of the multiple object tracking may be adjusted to substantially achieve and maintain a specified success rate, e.g., 85% or 90%, for the participant, although other success rates may be used as desired. In one embodiment, the exercise may begin with 3 target images, although in other embodiments, this initial value may be determined by a pre-exercise calibration or threshold determination, as described below in more detail.

In preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition, the multiple object tracking may be presented (and adjusted) in accordance with a maximum likelihood procedure (e.g., ZEST) applied to trials under that condition.

Moreover, as described below, the repeating may also include performing threshold assessments in conjunction with, or as part of, the exercise. A description of threshold determination/assessment is provided below.

Threshold Determination/Assessment

As indicated above, stimulus intensity is an adjustable attribute of a presented stimulus whereby the task or a trial in the task may be made more or less difficult. For example, as noted above, in one embodiment, the stimulus intensity may be the number of target images presented, although other attributes of the stimulus may be used as desired. The threshold is the value of the stimulus intensity at which the participant achieves a specified level of success, e.g., 0.9, corresponding to a 90% success rate. It should be noted that any other attribute or combination of attributes may be used as desired, the term stimulus intensity being intended to refer to any such adjustable attributes.

Exercise based assessments (i.e., threshold determination) are designed to assess a participant's threshold with respect to stimuli on a given exercise, and can be used to adjust stimulus presentation to (substantially) achieve and maintain a desired success rate for the participant, e.g., with respect to a particular exercise, task, or condition. As will be described below, such threshold determination may also be used to assess or determine a pre-training threshold that can then be used to calibrate the program to an individual's capabilities on various exercises, as well as serve as a baseline measure for assessing the participant's performance periodically during an exercise. Such assessment may also serve as a baseline measure to which post-training thresholds can be compared. Comparison of pre-training to post-training thresholds may be used to determine the gains made as a function of training with the cognition enhancement exercise or tasks described herein.

As noted above, there are various approaches whereby such thresholds may be assessed or determined, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, among others, although it should be noted that such methods have not heretofore been utilized in cognition enhancement training exercises using visual stimuli, as described herein.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5, although it should be noted that in some embodiments, there may be no upper bound to the intensity, such as, for example, when the stimulus intensity is the number of objects or images tracked). As used herein, and as described above, the term intensity (with respect to stimuli) refers to the value of the adaptive dimension variable being presented to the participant at any particular trial in a particular exercise. In other words, the intensity value is that parameter regarding the exercise stimuli that may be adjusted or adapted, e.g., to make a trial more or less difficult, which in preferred embodiments of the present exercise, may be the number of target images presented. The threshold is defined to be the mean of the Gaussian distribution for a specified success rate—e.g., a value yielding some specified success rate, e.g., 50%, 95%, etc.

The method may make some assumptions about the psychophysics:

1. The psychometric function has the same shape, except a shift along the stimulus intensity axis to indicate different threshold value.

2. The threshold value does not change from trial to trial.

3. Individual trials are statistically independent.

The primary idea of the ZEST procedure is as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1−p.

The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F.<predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65.

Thus, in some embodiments, a single stair ZEST procedure such as that described above may be used to adjust the intensity of the stimuli for the multiple object tracking during training. In one embodiment, during training the stimulus threshold approached and maintained may be determined corresponding to a success rate of the participant of 85%, although other success rates may be used as desired.

In contrast, in some embodiments, particularly with respect to the periodic assessments during the exercise (as opposed to the “per response” stimulus adjustment) a 2-stair ZEST procedure may be employed, where two independent tracks with starting values, preferably encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart. An exemplary implementation of this approach is described below with respect to the multiple object tracking threshold assessment.

As used herein, the parameters required for ZEST may include the mean of the prior P.D.F. (threshold estimate), the standard deviation of the prior P.D.F. (spread of threshold distribution), the standard deviation of the cumulative Gaussian distribution (slope of psychometric function), the maximum number of trials to run, and a confidence level and interval. Additionally, in one embodiment, the trial-by-trial data saved for analysis may include: the track used, the stimulus intensity presented, the subject's response, the mean of posterior P.D.F., and the standard deviation of the posterior P.D.F., as well as any other data deemed necessary or useful in determining and/or assessing the participant's threshold.

Thus, in preferred embodiments, a maximum likelihood procedure, such as a ZEST procedure, may be used to adjust the stimulus intensity of the multiple object tracking during training (e.g., via a single stair ZEST procedure per condition), and may also be used for assessment purposes at periodic stages of the exercise (e.g., via a dual stair ZEST procedure, describe below). In one embodiment, such assessment may occur at specified points during the exercise, e.g., at 0% (i.e., prior to beginning), 25%, 50%, 75%, and 100% (i.e., after completion of the exercise) of the exercise, where each training portion demarcated by assessment may be referred to as a segment. Thus, for example, in a 40-day exercise schedule, these assessments, which may be referred to as baseline measurements, may be made on days before and after training, and after 10, 20, and 30 days of training, to gauge improvements over the training time. An example of such assessment is now described.

A primary purpose of the multiple object tracking threshold assessment is to determine the maximum number of target images presented in the multiple object tracking task that a person can respond correctly to above a statistical threshold. The multiple object tracking assessment may be similar to the multiple object tracking exercise with respect to visual presentation, where the differences between the assessment and the exercise lie (at least primarily) in the movement or progression through the task and the data that are obtained from this movement for the assessment. The procedure is designed to obtain a threshold, which is a statistical rather than an exact quantity. In one embodiment, for the purposes of this exercise, the threshold may be defined as the number of target images presented in the multiple object tracking at which the participant will respond correctly a specified percentage, e.g., 50%, 85%, etc., of all trials for the task. In a preferred embodiment, being a computer based task, the multiple object tracking assessment may use the ZEST procedure to progress or move through the task, adjust the number of target images for the multiple object tracking, and determine the statistical threshold.

As noted above, many aspects of the multiple object tracking assessment may generally be similar, or possible even identical, to the multiple object tracking exercise task with respect to visual presentation. However, some aspects of the exercise version of multiple object tracking may not be necessary in the multiple object tracking assessment. For example, with regard to the GUI, in some embodiments, GUI elements such as score indicator, bonus indicator, etc., may not be necessary, and so may be omitted. Features or assets that may remain the same may include the sounds/animations that play after a participant responds correctly or incorrectly. The assessment stimulus presentation may also be identical to the training version.

The following describes one embodiment of a 2-stair (dual track) approach for determining a psychophysical threshold for a participant, e.g., an aging adult, where the stimulus intensity comprises the number of target images. Initially, first and second tracks may be initialized with respective numbers of target images based on an initial anticipated threshold, where the initial anticipated threshold is an initial estimate or guess of a number of target images for multiple object tracking corresponding to a specified performance level of the participant, e.g., a number of target images at which the participant responds correctly some specified percentage of the time, e.g., 50%, 90%, etc. For example, in one embodiment, the first track may be initialized to a first number of target images that is below the initial anticipated threshold, e.g., preferably just slightly below the initial anticipated threshold, and the second track may be initialized to a second number of target images that is (e.g., slightly) above the initial anticipated threshold. Thus, the initial numbers of target images of the two tracks may straddle the initial anticipated threshold.

The method elements 302-308 of FIG. 3 may be performed, as described above, where the plurality of images, including the plurality of target images and a plurality of distracter images, are presented in accordance with the number of target images of a specified one of either the first track or the second track. In other words, one of the tracks may be selected or otherwise determined, and the stimuli for the multiple object tracking task may be presented with a number of target images specified by the selected track. Thus, in preferred embodiments, the initial anticipated threshold, the first number of target images, the second number of target images, and the (to be determined) threshold, each is or specifies a respective number of target images. As also described above, the participant may be required to select or otherwise indicate the target images (310), and a determination may be made as to whether the participant selected the target images correctly (312).

The number of target images of the specified track may then be adjusted or modified, based on the participant's response. For example, the number of target images of the track may be modified in accordance with a maximum likelihood procedure, such as QUEST or ZEST, as noted above. In one embodiment, for each track, modifying the number of target images of the specified track based on the participant's response may include increasing the number of target images (e.g., by one) if the participant responds incorrectly, and decreasing the number of target images (e.g., by one) if the participant responds correctly. Thus, for each assessment trial (in a given track), the number of target images for that trial may be determined by the performance of the previous trial for that track. In other words, the participant's response to the stimulus determines that track's next number of target images via the maximum likelihood method.

Similar to 314 of FIG. 3, the visually presenting, requiring, determining, and modifying or adjusting (of the number of target images), may be repeated one or more times in an iterative manner, but in this case, the repeating is performed to determine respective final numbers of target images for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal. In preferred embodiments, the presenting, requiring, determining, and modifying, may be repeated until the numbers of target images of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective value, and the convergent values for the two tracks may be required to be within some distance or interval of each other.

A threshold for the participant may then be determined based on the respective final numbers of target images for the first track and the second track, where the threshold is or specifies the number of target images associated with the specified performance level of the participant. For example, as mentioned above, the determined threshold may specify the number of target images at which the participant responds correctly some specified percentage of the trials, e.g., 50%, 90%, etc., although it should be noted that any other percentage may be used as desired. In one embodiment, the threshold for the participant may be determined by averaging the respective final numbers of target images for the first track and the second track.

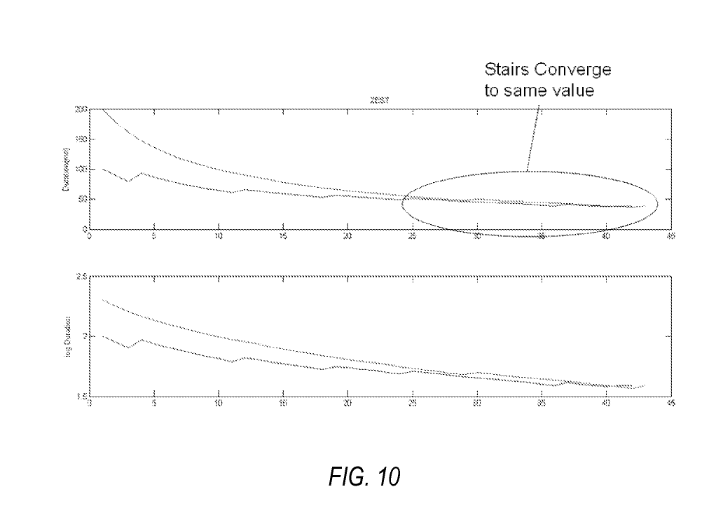

FIG. 10 illustrates an exemplary case where two tracks or “stairs” used in a ZEST threshold procedure are shown converging to a threshold value over a series of trials, where in this case the stimulus intensity is a duration, e.g., the presentation time of a stimulus. Note that in the top graph, duration vs. trials is plotted in a linear manner, whereas the bottom graph provides the same information but is logarithmic on the duration (vertical) axis. As may be seen, after about 25 trials, the two tracks or stairs converge to a value at or near 50 ms, thus, the two tracks, initialized respectively to values above and below an initial estimate of the threshold, converge to an approximation of the participant's actual stimulus threshold for the exercise.

In some embodiments, the presenting, requiring, determining, and modifying may compose performing a trial, and certain information may be saved on a per trial basis. For example, in one embodiment, for each trial, the method may include saving one or more of: which track was used in the trial, the number of target images used in the trial, the number of distracter images presented to the participant in the trial, the participant's selection, the correctness or incorrectness of the participant's response, the mean of a posterior probability distribution function for the maximum likelihood procedure, and the standard deviation of the posterior probability distribution function for the maximum likelihood procedure, among others. Of course, any other data related to the trial may be saved as desired, e.g., the distinguishing attribute of the target image, eccentricity of the target image, and/or any other condition of the tracking task.

Additionally, in some embodiments, various parameters for the maximum likelihood procedure besides the respective (initial) durations of the two tracks may be initialized, such as, for example, the standard deviation of a cumulative Gaussian psychometric function for the maximum likelihood procedure, and/or the standard deviation of a prior threshold distribution for the maximum likelihood procedure.

In one embodiment, the method may include determining the initial anticipated threshold. For example, the initial anticipated threshold may be determined based on one or more of: the age of the participant, calibration trials performed by the participant, and/or calibration trials performed by other participants, e.g., in a “pilot” program, although it should be noted that any other type of information may be used as desired to determine the initial anticipated threshold.

In some embodiments, certain information may be maintained and recorded over the course of the exercise. For example, in one exemplary embodiment, the following information may be recorded: the name of the participant; the age of the participant; the gender of the participant; the number of assessments/training segments completed; all scores achieved during the exercise; all threshold estimates for training and assessments; ZEST progressions used in the exercise; task type, conditions and colors used for each segment; screen frame rate and spatial resolution; time/date for each session; time spent on each task; and the number of training segments and assessments completed. Of course, this information is meant to be exemplary only, and other information may be recorded as desired.

In one embodiment, one or more auxiliary trials, referred to as “Eureka trials”, may be performed periodically, e.g., every 20 trials in the exercise, in which the stimulus intensity, e.g., the number of target images, is deliberately set to be below the current value used in the exercise. For example, each such trial may be a non-ZEST trial that is easier than trials performed with the current threshold estimate, e.g. the stimulus intensity may be (temporarily) set at 75% of current the current threshold/intensity, although other values may be used as desired. These trials may help encourage the participant to continue with the exercise.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the task. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

Exemplary Exercise Flow

In light of the above description, the following presents an exemplary flow of the exercise, according to one embodiment, although it should be noted that this particular embodiment is not intended to limit the exercise to any particular flow, schedule, or scheme. In this embodiment, the exercise requires 10 hours of training. The exemplary flow is as follows:

First, a practice session may be performed, including 5 trials for each of the four task types, i.e., Repel/Overlap/Repel+occluders/Overlap+occluders. A first, pre-training assessment may then be performed, after which training on all task types may be performed. A second assessment may be performed after 25% of training has been completed, after which training continues on all tasks. A third assessment may be made after 50% of training has been completed, then training continues on all tasks. A fourth assessment may be made after 75% of training has been completed, then training continues on all tasks. Finally, a fifth assessment may be performed after 100% of the training has been completed. Of course, in other embodiments, the assessments may be performed at other points in the exercise as desired.

It should be noted that the particular exercise disclosed herein is meant to be exemplary, and that other repetition-based cognitive training exercises using visual stimuli with multiple stimulus sets may be used as desired, possibly in combination. In other words, the multiple object tracking exercise described herein is but one example of a cognitive training exercise using a computing system to present visual stimuli to a participant, record the participant's responses, and modify some aspect of the visual stimuli based on these responses, where these method elements are repeated in an iterative manner using multiple sets of stimuli to improve cognition in the participant. Note particularly that such cognitive training using a variety of such visual stimulus-based exercises, possibly in a coordinated manner, is contemplated.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A computer-implemented method for enhancing cognition in a participant, utilizing a computing device to present visual stimuli for training, and to record responses from the participant, the method comprising:
providing one or more images, wherein the one or more images are available for visual presentation to the participant;
visually presenting a plurality of images based on the one or more images in a visual field to the participant, wherein the plurality of images comprises a plurality of target images and a plurality of distracter images, and wherein said visually presenting comprises:
graphically indicating each of the plurality of target images for a first time period;
moving each of the plurality of images in the visual field for a second time period, wherein during the second time period said graphically indicating is not performed;
requiring the participant to select the target images from the plurality of images;
determining whether the participant selected the target images correctly; and
repeating said visually presenting, said requiring, and said determining one or more times in an iterative manner to improve the participant's cognition.

2. The method of claim 1, wherein said requiring the participant to select the target images comprises:
providing a period of time in which the participant is to select the target images; and
recording the selections made by the participant.

3. The method of claim 1, wherein said requiring the participant to select the target images comprises:
allowing the participant to make a number of selections, wherein the number of selections is equal to the number of target images.

4. The method of claim 1, wherein said visually presenting the plurality of images comprises visually presenting the plurality of images at a specified stimulus intensity.

5. The method of claim 4, wherein said repeating comprises:
adjusting the stimulus intensity for said visually presenting based on whether the participant selected the target images correctly;
wherein said adjusting is performed using a maximum likelihood procedure.

6. The method as recited in claim 6, wherein the maximum likelihood procedure comprises one or more of:
a QUEST (quick estimation by sequential testing) threshold procedure; or
a ZEST (zippy estimation by sequential testing) threshold procedure.

7. The method of claim 5, wherein the stimulus intensity comprises the number of target images visually presented.

8. The method of claim 7, wherein said adjusting the stimulus intensity comprises:
if the participant correctly selects the target images, increasing the number of target images.

9. The method of claim 7, wherein said adjusting the stimulus intensity comprises:
if the participant incorrectly selects the target images, decreasing the number of target images.

10. The method of claim 5, wherein the stimulus intensity comprises the presentation time of the visually presented images, wherein said adjusting the stimulus intensity comprises:
if the participant incorrectly selects the target images, increasing the presentation time of the images; and
if the participant correctly selects the target images, decreasing the presentation time of the images.

11. The method of claim 5, wherein the stimulus intensity comprises the speed of the images during said moving, wherein said adjusting the stimulus intensity comprises:
if the participant correctly selects the target images, increasing the speed of the images during said moving; and
if the participant incorrectly selects the target images, decreasing the speed of the images during said moving.

12. The method of claim 5, wherein the stimulus intensity comprises one or more of:
speed of the target images and the distracter images;
size of the target images and the distracter images;
presentation time of the target images and the distracter images, wherein said presentation time comprises the first time period and/or the second time period;
eccentricity of initial locations of the target images;
number of occluders in the visual field, wherein each occluder is operable to occlude target images and distracter images that move behind the occluder;
size of the visual field; or
visual appearance of the images.

13. The method of claim 5, wherein said adjusting the stimulus intensity comprises:
adjusting the stimulus intensity to approach and substantially maintain a specified success rate for the participant.

14. The method of claim 13, wherein said adjusting the stimulus intensity to approach and substantially maintain a specified success rate for the participant is performed for each of a plurality of conditions.

15. The method of claim 13, wherein said adjusting the stimulus intensity to approach and substantially maintain a specified success rate for the participant uses a single stair maximum likelihood procedure.

16. The method of claim 6, wherein said visually presenting, said requiring, and said determining composes performing a trial.

17. The method of claim 16, wherein said repeating comprises:
performing a plurality of trials under each of a plurality of conditions, wherein each condition specifies one or more attributes of the plurality of images or their presentation.

18. The method of claim 17, wherein each of the plurality of conditions specifies one or more of:
movement of the target images and the distracter images;
size of the target images and the distracter images;
presentation time of the target images and the distracter images, wherein said presentation time comprises the first time period and/or the second time period;
eccentricity of initial locations of the target images;
number of occluders in the visual field, wherein each occluder is operable to occlude target images and distracter images that move behind the occluder;
size of the visual field; or
visual appearance of the images.

19. The method of claim 18, wherein the visual field comprises one or more occluders, and wherein after said moving, each of the plurality of images is not occluded.

20. The method of claim 17, wherein said specifying movement of the target images and the distracter images comprises specifying one or more of:
speed of the target images and the distracter images; or
whether or not the target images and the distracter images can overlap.

21. The method of claim 20, wherein said specifying speed of the target images and the distracter images comprises:
specifying a range of speed for the target images and the distracter images.

22. The method of claim 20, wherein during said moving, the plurality of images are allowed to overlap, and wherein after said moving, none of the plurality of images overlap.

23. The method of claim 17, wherein said repeating comprises:
assessing the participant's performance a plurality of times during said repeating.

24. The method of claim 23, wherein said assessing the participant's performance a plurality of times is performed according to the maximum likelihood procedure.

25. The method of claim 24, wherein said assessing the participant's performance a plurality of times is performed using a 2-stair maximum likelihood procedure.

26. The method of claim 1, wherein selection of an image is performed by the participant placing a cursor over the image and clicking a mouse.

27. The method of claim 1, wherein said visually presenting comprises:
setting initial positions for each of the plurality of images.

28. The method of claim 1, wherein said moving comprises:
setting initial speed and direction for each of the plurality of images.

29. The method of claim 28, wherein said setting initial speed and direction for each of the plurality of images comprises setting initial speed and direction for each of the plurality of images randomly.

30. The method of claim 28, wherein said moving comprises:
changing speed and/or direction of at least a subset of the plurality of images one or more times during said moving.

31. The method of claim 1, further comprising:
recording whether the participant correctly selected the target images.

32. The method of claim 1, further comprising:
indicating whether the participant selected the target images correctly, wherein said indicating is performed audibly and/or graphically.

33. The method of claim 32, wherein said indicating whether the participant selected the target images correctly comprises:
for each selection, indicating whether the participant correctly selected a target image.

34. The method of claim 1, further comprising:
graphically indicating each of the plurality of target images after said determining.

35. The method of claim 1, further comprising:
performing trials in one or more practice sessions under each of one or more conditions.

36. The method of claim 1, wherein said repeating occurs a specified number of times each day, for a specified number of days.

37. A computer-readable memory medium that stores program instructions for enhancing cognition in a participant, utilizing a computing device to present visual stimuli for training, and to record responses from the participant, wherein the program instructions are executable by a processor to perform:
providing one or more images, wherein the one or more images are available for visual presentation to the participant;
visually presenting a plurality of images based on the one or more images in a visual field to the participant, wherein the plurality of images comprises a plurality of target images and a plurality of distracter images, and wherein said visually presenting comprises:
graphically indicating each of the plurality of target images for a first time period;
moving each of the plurality of images in the visual field for a second time period, wherein during the second time period said graphically indicating is not performed;
requiring the participant to select the target images from the plurality of images;
determining whether the participant selected the target images correctly; and
repeating said visually presenting, said requiring, and said determining one or more times in an iterative manner to improve the participant's cognition.
